(19) United States
(12) Patent Application Publication
(10) Pub. No.: US 2016/0034330 A1
(43) Pub. Date: Feb. 4, 2016

(54) INFORMATION-PROCESSING DEVICE AND METHOD

(71) Applicant: Kabushiki Kaisha Toshiba, Tokyo (JP)

(72) Inventors: Tetsuo Kuribayashi, Yokohama Kanagawa (JP); Michihiko Umeda, Yokohama Kanagawa (JP); Hironori Kanno, Fussa Tokyo (JP); Nobuhiro Sugawara, Yokohama Kanagawa (JP); Seiji Toda, Kawasaki Kanagawa (JP)

(21) Appl. No.: 14/566,023

(22) Filed: Dec. 10, 2014

Related U.S. Application Data
(60) Provisional application No. 62/030,275, filed on Jul. 29, 2014.

(51) Int. Cl. G06F 11/07

(52) U.S. Cl. CPC G06F 11/079; G06F 11/073; G06F 11/0751

(57) ABSTRACT

According to one embodiment, there is provided an information-processing device which includes a storage medium and a controller configured to acquire a delay time in access to storage area included in the storage medium for every storage area with reference to a time at which an access is performed without performing retrying on the storage area based on first information relating to an access history with respect to the storage area, and to determine the storage area of which the delay time exceeds a predetermined allowable delay time as a defective area.

### CROSS-REFERENCE TO RELATED APPLICATIONS

This application is based upon and claims the benefit of priority from U.S. Provisional Application No. 62/030,275, filed on Jul. 29, 2014; the entire contents of which are incorporated herein by reference.

### FIELD

Embodiments described herein relate generally to an information-processing device and an information-processing method.

### BACKGROUND

In a redundant arrays of inexpensive disks (RAID) system using a storage device such as a magnetic disk device or a solid state drive (SSD), when the storage device included in the RAID is failure, the RAID is subjected to a recovery process (so-called rebuild process). In the RAID system, the rebuild process is generally performed. The rebuild process is a process in which the data stored in the failure storage device is recovered using data stored in the storage devices other than the failure storage device among a plurality of storage devices included in the RAID, and recovered data is written in predetermined storage device (replacement device).

A time required for the rebuild process (a RAID recovery time) becomes long as the capacity of the storage device increases. Therefore, degradation in performance of the RAID system during the rebuild process and a risk of failure in other storage devices is increased. Then, there is proposed a rebuild assist function of achieving reduction in the RAID recovery time through the rebuild process using available data among the data stored in the failure storage device. In the rebuild assist function, prediction (determination) of inaccessible defective area is required with respect to the failure storage device.

However, in the rebuild assist function, in a case where the defective area is not able to be correctly predicted, a delay occurs by retrying during the rebuild process and a defect range is excessively predicted to increase an access load on other storage devices, thereby causing the RAID recovery time to be long.

### BRIEF DESCRIPTION OF THE DRAWINGS

FIG. 1 is a diagram illustrating an example of a hardware configuration of a magnetic disk device to which an information-processing device according to a first embodiment is applied;

FIG. 2 is a diagram illustrating an example of a block group address information table in which the magnetic disk device according to the first embodiment is stored;

FIG. 3 is a diagram illustrating an example of a block group defect information table in which the magnetic disk device according to the first embodiment is stored;

FIG. 4 is a flowchart illustrating an example of a flow of an access process to a disk of the magnetic disk device according to the first embodiment;

FIG. 5 is a flowchart illustrating an example of a flow of an update process of the block group defect information table by the magnetic disk device according to the first embodiment;

FIG. 6 is a flowchart illustrating an example of a flow of a rebuild assist mode enabling process by the magnetic disk device according to the first embodiment;

FIG. 7 is a flowchart illustrating an example of a flow of a rebuild assist process (a read/write process in a rebuild assist mode) by the magnetic disk device according to the first embodiment;

FIG. 8 is a flowchart illustrating an example of a flow of an acquisition process of a defect determination result by the magnetic disk device according to the first embodiment; and

FIGS. 9A, 9B, and 9C are diagrams for explaining an example of a process of determining that an upper-level group set is a defective area in a magnetic disk device according to a second embodiment.

### DETAILED DESCRIPTION

In general, according to one embodiment, embodiments, an information-processing device includes a storage medium and a controller configured to acquire a delay time in access to storage area included in the storage medium for every storage area with reference to a time at which access is performed without performing retrying on the storage area based on first information relating to an access history with respect to the storage area, and to determine the storage area of which the delay time exceeds a predetermined allowable delay time as a defective area.

Hereinafter, an information-processing device and an information-processing method according to embodiments will be described in detail with reference to the accompanying drawings. In addition, the invention is not limited to the embodiments.

### First Embodiment

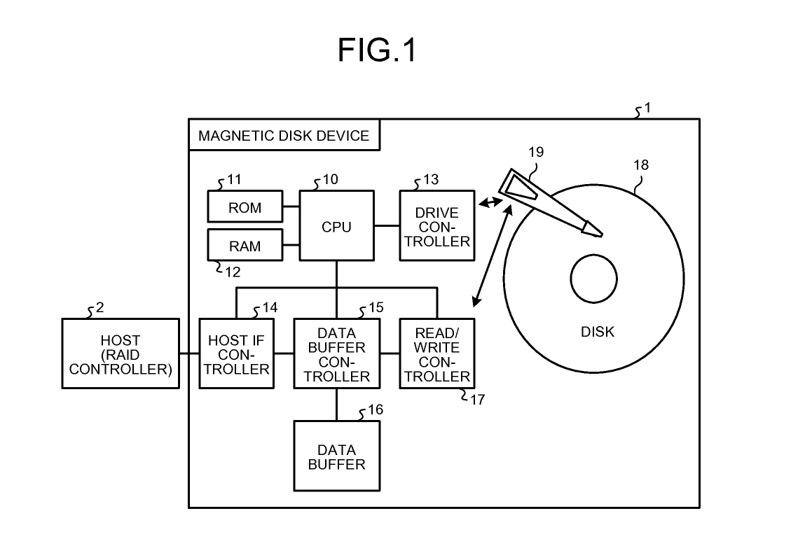

First, a hardware configuration of a magnetic disk device to which an information-processing device according to a first embodiment is applied will be described using FIG. 1. FIG. 1 is a diagram illustrating an example of the hardware configuration of the magnetic disk device to which the information-processing device according to the first embodiment is applied. In the following description, an example in which the information-processing device according to the embodiment is applied to the magnetic disk device will be described, but the invention is not limited thereto, and the information-processing device according to the embodiment may be applied to a memory device such as an SSD.

As illustrated in FIG. 1, a magnetic disk device 1 according to the embodiment includes a central processing unit (CPU) 10, a read only memory (ROM) 11, a random access memory (RAM) 12, a drive controller 13, a host IF (Interface) controller 14, a data buffer controller 15, a data buffer 16, a read/write controller 17, a disk 18, and a head stack assembly 19.

The disk 18 (an example of a storage medium) is made of a magnetic recording medium or the like, and includes a plurality of block groups (an example of a storage area) which is readable or writable with data. In the embodiment, the block group corresponds to a half rotation of each track of the disk 18. In the embodiment, the half rotation of each track on the disk 18 is considered as one block group, but the invention is not limited thereto and may be applied to any scheme as long as one area in the surface of the disk 18 can be set as a block group. For example, each track of the disk 18 may be set as one block group.

The head stack assembly 19 is a mechanism which holds a head and moves the head on a predetermined position (a position at which data is read or written) on the disk 18.

The CPU 10 is a controller which controls the entire magnetic disk device 1. Specifically, the CPU 10 performs controls as follows: an access (reading or writing data) to the disk 18, a defect determination process of determining whether the block group is a defective area, a rebuild assist process of informing a host 2 of the block group which is determined as a defective area when data stored in the block group is rebuilt, and a rebuild assist mode enabling process of detecting an abnormality at every physical element of the disk 18 before the rebuild assist process.

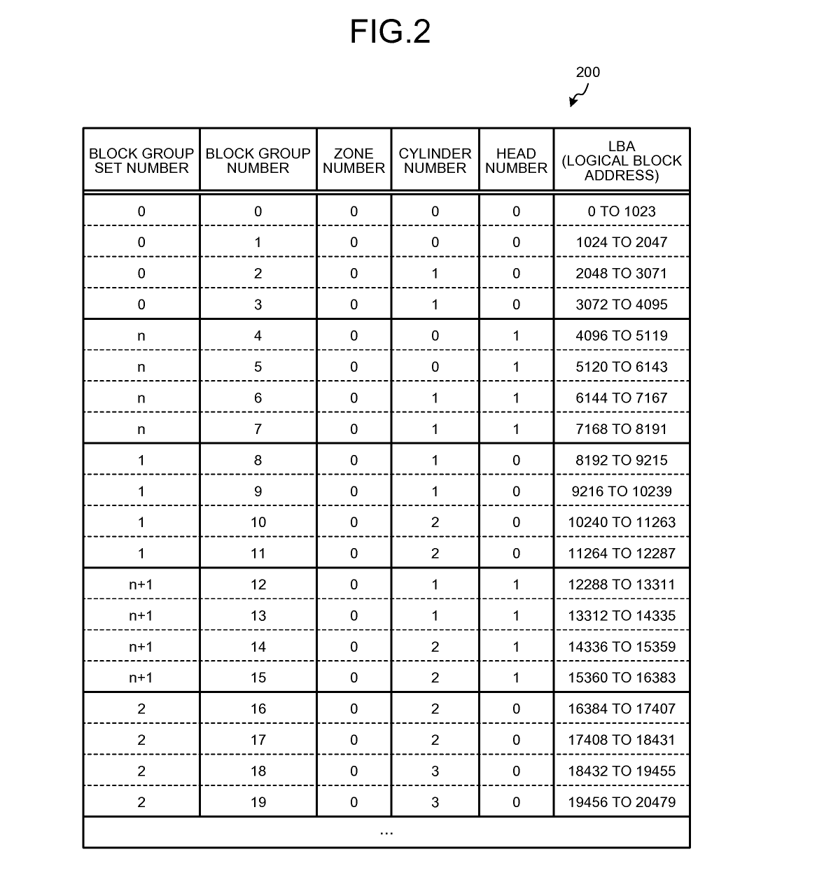

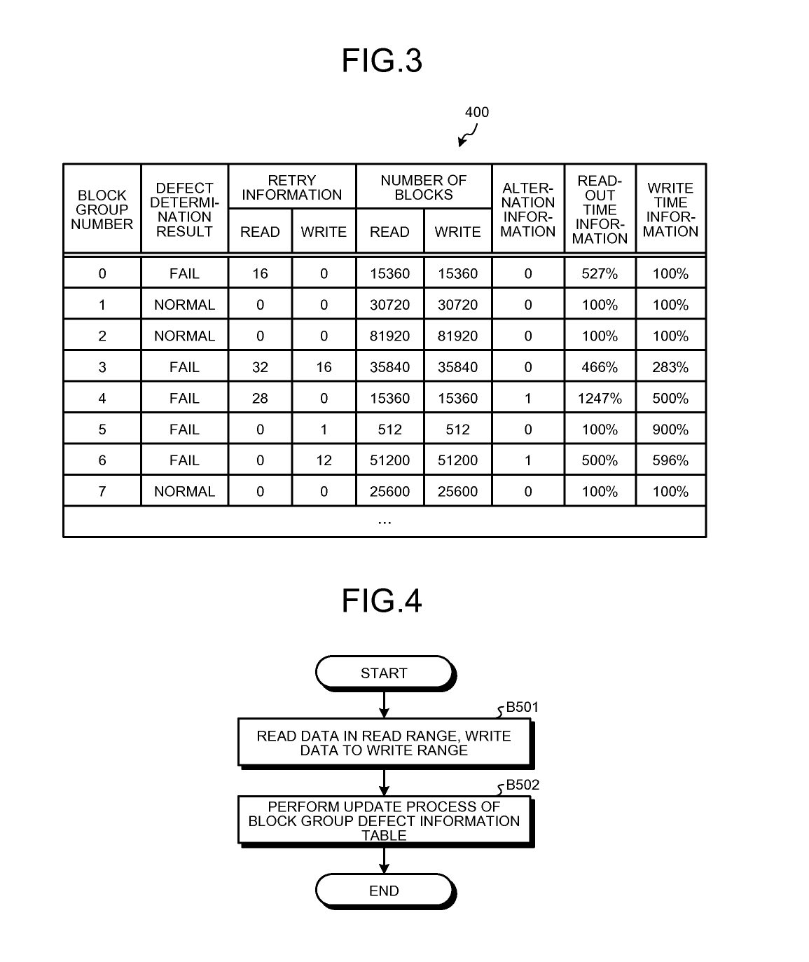

The ROM 11 stores various programs which are executed by the CPU 10. The RAM 12 is used as a working area of the CPU 10. In the embodiment, the RAM 12 (an example of a storage portion) holds a block group address information table 200 (see FIG. 2) storing logical block addresses (LBA) of the block groups of the disk 18, and a block group defect information table 400 (see FIG. 3) storing results of the defect determination process by the CPU 10.

The drive controller 13 is controlled by the CPU 10, and executes a writing of data received from the host 2 to the disk 18 and a reading of data from the disk 18.

The host IF controller 14 controls transmitting or receiving data and command between the magnetic disk device 1 and the host 2. The host 2, for example, is provided with a RAID (Redundant Arrays of Inexpensive Disks) controller which is included in a personal computer (PC) or a server. The RAID controller transmits or receives various types of information such as data and command with the magnetic disk device 1 in conformity to an interface standard such as a SATA (Serial ATA) standard or an SAS (Serial Attached SCSI) standard.

The data buffer controller 15 is controlled by the CPU 10, and writes in the data buffer 16 with data (write data) and data (read data). The write data is data which is received from the host 2 and written in the disk 18. The read data is data which is read from the disk 18. Further, the data buffer controller 15 reads the write data from the data buffer 16 and outputs the data to the read/write controller 17. Furthermore, the data buffer controller 15 reads the read data from the data buffer 16 and outputs the data to the host 2 through the host IF controller 14. In other words, the data buffer 16 temporarily stores the write data and the read data.

The read/write controller 17 is controlled by the CPU 10 and outputs a read/write signal instructing an access (reading or writing data) to the disk 18 to the head stack assembly 19. Therefore, the read/write controller 17 controls an access to the disk 18.

Next, the block group address information table 200 stored in the RAM 12 which includes the magnetic disk device 1 according to the embodiment will be described using FIG. 2. FIG. 2 is a diagram illustrating an example of the block group address information table stored in the magnetic disk device according to the first embodiment.

As illustrated in FIG. 2, the block group address information table 200 stores a zone number as an example of information usable to identify a zone in the disk 18 where the block group is disposed, a cylinder number as an example of information usable to identify a cylinder in the disk 18 to which the block group belongs, a head number as an example of information usable to identify a head which performs an access to the block group, a logical block address (LBA) of a sector which is included in the block group, and a block group set number as an example of information usable to identify a block group set (an example of a first storage area set) in association with the block group set number as an example of information usable to identify the block group.

Herein, the block group set includes a plurality of block groups which are classified according to a classification condition based on the physical element (for example, head, zone, cylinder, and the like) of the block group. Further, the classification condition is a condition which is set based on the physical element of the block group and used to classify the block groups. In the embodiment, the classification condition is that the plurality of block groups has the same head number, the plurality of block groups has the same zone number, and the cylinder numbers of the plurality of block groups are continuous.

Next, a classification method of the block group in the magnetic disk device 1 according to the embodiment will be described using FIG. 2.

In the embodiment, as illustrated in FIG. 2, the CPU 10 classifies the plurality of block groups such that the block groups having the same head number, the same zone number, and the continuous cylinder numbers are classified into one block group set. For example, as illustrated in FIG. 2, four block groups identified by the block group numbers 0 to 3 are common in the zone number 0 and the head number 0, and the cylinder numbers 0 and 1 are continuous. Therefore, the CPU 10 classifies the four block groups into one block group set (the block group number 0). It is also possible to make a classification into two block groups according to a combination of the zone number, the cylinder number, and into four block groups by dividing the cylinders into two parts.

Next, the block group defect information table 400 stored in the RAM 12 which includes the magnetic disk device 1 according to the embodiment will be described using FIG. 3. FIG. 3 is a diagram illustrating an example of the block group defect information table stored in the magnetic disk device according to the first embodiment.

As illustrated in FIG. 3, the block group defect information table 400 stores a defect determination result, retry information, the number of blocks, alternation information, read-out time information, and write time information by associating with the block group number. These types of information illustrate an example of first information relating to an access history with respect to the block group. Herein, the defect determination result is a result of the defect determination process performed by the CPU 10 on the block group. In the embodiment, in a case where the block group is determined as a defective area, the defect determination result shows “Fail”, and in a case where the block group is normal, the result shows “Normal”.

The retry information is information indicating the number of times of retrying in data-reading performed on the block group, and the number of times of retrying in data-writing performed on the block group.

The number of blocks is information indicating the number of times to read data from a sector included in the block group, and the number of times to write data to a sector included in the block group. The alternation information indicates the number of alternation sectors (an example of alternation areas) on which an alternation process is performed in access to the block group.

The read-out time information is information indicating a ratio of time required for reading data out of the block group with reference to the time at which the reading-out (access) of the data is performed without performing the retrying on the block group. The write time information is information indicating a ratio of time required for writing data to the block group with reference to the time at which the writing (access) of the data is performed without performing the retrying on the block group.

Next, an access process on the disk 18 of the magnetic disk device 1 according to the embodiment will be described using FIG. 4. FIG. 4 is a flowchart illustrating an example of a flow of an access process to a disk of the magnetic disk device according to the first embodiment.

The CPU 10 receives a command from the host 2 through the host IF controller 14. The command can specify a block group (hereinafter, referred to as a read range) from which the data is read or a block group (hereinafter, referred to as a write range) to which the data is written.

The CPU 10 performs a reading the data out of the read range specified by the received command or a writing the data to the write range specified by the received command (B501).

When performing a reading or a writing the data with respect to the block group included in the disk 18, the CPU 10 performs an update process of the block group defect information table 400 stored in the RAM 12 (B502). When the update process of the block group defect information table 400 is ended, the CPU 10 ends the access to the block group.

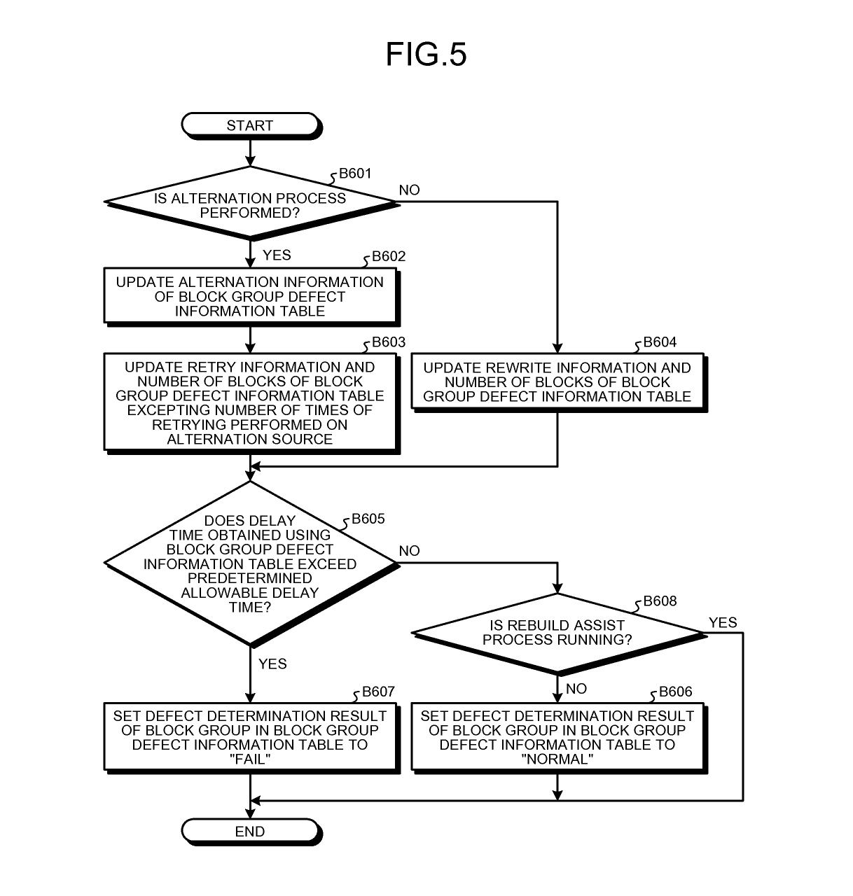

Next, the update process of the block group defect information table 400 by the magnetic disk device 1 according to the embodiment will be described using FIG. 5. FIG. 5 is a flowchart illustrating an example of a flow of an update process of the block group defect information table by the magnetic disk device according to the first embodiment.

First, the CPU 10 determines whether the alternation process is performed on the alternation sector included in the disk 18 in access to the block group (hereinafter, referred to as an update target group) in the write range (or the read range) accessed in B501 of FIG. 4 (B601).

In a case where the alternation process is performed on the alternation sector (Yes in B601), the CPU 10 updates the alternation information stored in association with the block group number of the update target group in the block group defect information table 400 (B602). In the embodiment, in access to the update target group, the CPU 10 adds the number of sectors (hereinafter, referred to as an alternation source) subjected to the alternation process among the sectors included in the update target group to the number of sectors indicated by the alternation information stored in association with the block group number of the update target group.

Next, the CPU 10 updates the retry information and the number of blocks stored in association with the block group number of the update target group in the block group defect information table 400 excepting the number of times of the retrying performed on the alternation source (B603). In the embodiment, in a case where the data is read out of the update target group, the CPU 10 adds the number of times to retry the reading performed in reading the data out of the update target group to the number of times of the retrying indicated by the retry information (read) stored in association with the block group number of the update target group excepting the number of times to retry the reading performed on the alternation source.

Further, in a case where the data writing is performed on the update target group, the CPU 10 adds the number of times to retry the writing performed in writing the data to the update target group to the number of times of the retrying indicated by the retry information (write) stored in association with the block group number of the update target group excepting the number of times to retry the writing performed in writing the data to the alternation source.

In a case where the alternation process is not performed on the alternation sector (No in B601), the CPU 10 updates the retry information and the number of blocks (read or write) stored in association with the block group number of the update target group in the block group defect information table 400 without updating the alternation information of the block group defect information table 400 (B604).

In the embodiment, in a case where the data reading is performed on the update target group, the CPU 10 adds the number of sectors that are included in the update target group and that are actually subjected to the data reading (read) to the number of blocks (read) stored in association with the block group number of the update target group. Further, in a case where the data writing is performed on the update target group, the CPU 10 adds the number of sectors that are included in the update target group and that are actually subjected to the data writing (write) to the number of blocks (write) stored in association with the block group number of the update target group.

Next, the CPU 10 (an example of the controller) calculates a delay time in access to the update target group based on information (in the embodiment, the retry information, the number of blocks, the alternation information, and the like stored in the block group defect information table 400) relating to the access history with respect to the update target group, and determines whether the delay time exceeds a predetermined allowable delay time (B605). Herein, the delay time is a delay time in access to the block group with reference to the time when the access is performed without performing the retrying on the block group. The predetermined allowable delay time is a delay time which is allowed to the block group in access with reference to the time when the access is performed without performing the retrying on the block group.

In the embodiment, the CPU 10 adds a time (hereinafter, referred to as a first delay time) required for accessing a sector which is assigned as the alternation sector and a time (hereinafter, referred to as a second delay time) required for the retrying in the alternation process which is performed in access to the update target group. Specifically, the CPU 10 calculates the first delay time using the following Equation (1).

First delay time=Number of Alternation sectors×(Seek time×2+Rotation waiting time+Alternation sector access time) (1)

Herein, the number of alternation sectors is the number of alternation sectors indicated by the alternation information stored in association with the block group number of the update target group in the block group defect information table 400. The seek time is a time required for seeking the alternation sector. In the embodiment, the seek time is an average time required for seeking the alternation sector. The rotation waiting time is a time required for rotating the disk 18 by one rotation. The alternation sector access time is a time required for accessing (reading or writing the data) the alternation sector.

Further, the CPU 10 calculates the second delay time using the following Equation (2).

Second delay time=Rotation waiting time×Number of times of retrying (2)

Herein, the rotation waiting time is a time required for making the disk 18 rotate by one rotation. The number of times of the retrying is the number of occurrence times of the retrying performed per one track in access to the update target group, and is calculated using the following Equation (3).

Number of times of retrying=(Number of times of retrying/Number of Blocks)×Number of sector of One track (3)

Herein, the number of times of the retrying is the number of times of the retrying indicated by the retry information (the retry information (read) in a case where the update target group is the read range, and the retry information (write) in a case where the update target group is the write range) of the update target group. The number of blocks is the number of blocks (the number of blocks (read) in a case where the update target group is the read range, and the number of blocks (write) in a case where the update target group is the write range) of the update target group.

Further, in the embodiment, in a case where the update target group is the read range, the CPU 10 calculates the read-out time information using the following Equation (4). On the other hand, in a case where the update target group is the write range, the CPU 10 calculates the write time information using the following Equation (4). Then, the calculated read-out time information (or the write time information) is stored in the block group defect information table 400 in association with the block group number of the update target group.

Read-out time information (or Write time information)=((Normal access time+Delay time)/Normal access time)×100 (4)

Herein, the normal access time is a time at which an access is performed without performing the retrying on the block group.

Then, in a case where the calculated read-out time information (or the write time information) exceeds a ratio (in the embodiment, 300%) of an access allowable time with reference to the normal access time, the CPU 10 determines that the update target group is a defective area. Herein, the access allowable time is a time for allowing the block group to be accessed, and a time obtained by adding the allowable delay time to the normal access time. Therefore, the CPU 10 determines that the update target group of which the delay time exceeds the predetermined allowable delay time is a defective area.

In other words, in a case where the delay time does not exceed the predetermined allowable delay time (No in B605), the CPU 10 determines whether the rebuild assist process is running (B608). In a case where the rebuild assist process is not running (No in B608), the CPU 10 sets the defect determination result stored in association with the block group number of the update target group to “Normal” in the block group defect information table 400 (B606). Then, the CPU 10 ends the update process of the block group defect information table 400. On the other hand, in a case where the rebuild assist process is running (Yes in B608), the CPU 10 ends the update process of the block group defect information table 400 without updating the defect determination result.

On the other hand, in a case where the delay time exceeds the predetermined allowable delay time (Yes in B605), the CPU 10 sets the defect determination result stored in association with the block group number of the update target group to “Fail” in the block group defect information table 400 (B607). Therefore, during the rebuilding of the data stored in the block group, it is possible to reduce a risk that the defective area is not correctly predicted or that the defective area is excessively predicted, so that a time required for the rebuilding can be reduced. Then, the CPU 10 ends the update process of the block group defect information table 400. In the embodiment, when a read or write operation is performed, the defect determination result of the block group is updated. However, before the read or write operation is performed after the rebuild assist mode enabling process, if the defect determination result of the block group is updated, the defect determination process of the block group may be performed at any timing.

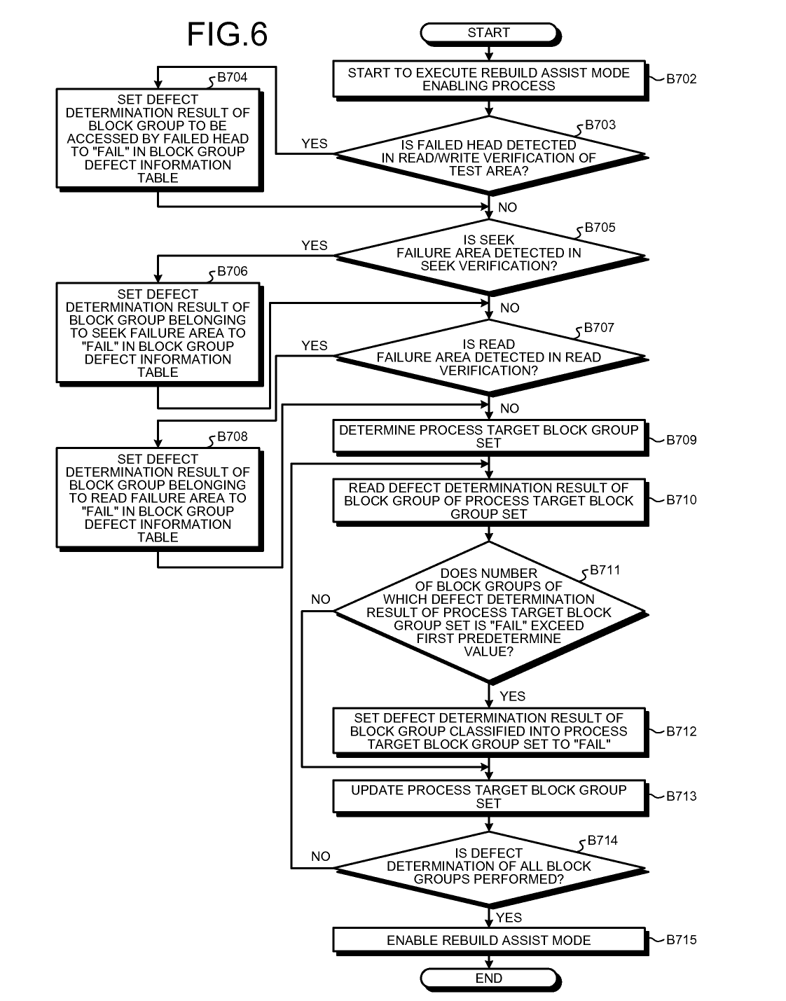

Next, a rebuild assist mode enabling process by the magnetic disk device 1 according to the embodiment will be described using FIG. 6. FIG. 6 is a flowchart illustrating an example of a flow of the rebuild assist mode enabling process by the magnetic disk device according to the first embodiment.

In a case where a command to order to execute the rebuild assist process is received from the host 2 through the host IF controller 14, the CPU 10 starts to execute the rebuild assist mode enabling process. The rebuild assist mode enabling process detects abnormality of the disk 18 for every physical element (for example, head, zone, and the like) of the disk 18, and determines a block group having an abnormal physical element detected among the block groups included in the disk 18 as a defective area (B702).

First, the CPU 10 controls the drive controller 13 to perform a read/write verification in which a predetermined test area in a data storage area included in the disk 18 is accessed (reading and writing data). Then, through the read/write verification, the CPU 10 determines whether a head failed among the heads included in the head stack assembly 19 (hereinafter, referred to as a failed head) is detected (B703).

In a case where it is determined that the failed head is detected (Yes in B703), the CPU 10 determines a block group to be accessed by the failed head which is determined that the failure is detected among the block groups included in the disk 18 as the defective area. Furthermore, the CPU 10 sets the defect determination result stored in association with the block group number of the block group (that is, the block group to be accessed by the failed head) determined as the defective area to “Fail” in the block group defect information table 400 (B704).

In a case where the failed head is not detected (No in B703) or after the defect determination result becomes “Fail” (B704), the CPU 10 controls the drive controller 13 to perform a seek verification in which a head included in the head stack assembly 19 is sought and it is determined whether a seek failure area of which the head is unable to be sought in the disk 18 is detected (B705).

In a case where it is determined that the seek failure area is detected (Yes in B705), the CPU 10 determines that the block group belonging to the detected seek failure area among the block groups included in the disk 18 is the defective area. Further, the CPU 10 sets the defect determination result stored in association with the block group number of the block group (that is, the block group belonging to the seek failure area) determined as the defective area to “Fail” in the block group defect information table 400 (B706).

In a case where it is determined that the seek failure area is not detected (No in B705) or after the defect determination result becomes “Fail” (B706), the CPU 10 controls the drive controller 13 to perform a read verification in which it is determined whether a read failure area from which data is not read is detected in the data storage area included in the disk 18 (B707).

In a case where the read failure area is detected (Yes in B707), the CPU 10 determines that the block group belonging to the detected read failure area among the block groups included in the disk 18 is the defective area. Further, in the block group defect information table 400, the CPU 10 sets the defect determination result stored in association with the block group number of the block group (that is, the block group belonging to the read failure area) determined as the defective area to “Fail” (B708). Then, in a case where it is determined that the read failure area is not detected (No in B707) and after the defect determination result becomes “Fail” (B708), the CPU 10 ends the rebuild assist mode enabling process.

Further, in the embodiment, the CPU 10 performs, following the rebuild assist mode enabling process, a process of determining that the block group set in which the number of “Fail” block groups as the defect determination result exceeds a first predetermined value is the defective area. The CPU 10 determines the block group set (that is, the block group set having a block group set number of 0) having a minimum block group set number among the block group sets included in the disk 18 as a process target block group set which is a target to determine a defective area (B709).

Next, the CPU 10 reads the defect determination results of the respective block groups belonging to the process target block group set out of the block group defect information table 400 (B710). Then, the CPU 10 determines whether the number of “Fail” block groups as the read-out defect determination result exceeds the first predetermined value among the block group belonging to the process target block group set (B711). Herein, the first predetermined value is the number of block groups to determine the block group set as the defective area.

In a case where the number of “Fail” block groups as the read-out defect determination result exceeds the first predetermined value (Yes in B711), the CPU 10 sets the defect determination results of all the block groups belonging to the process target block group set to “Fail” in the block group defect information table 400 (B712). In other words, the CPU 10 determines the process target block group set in which the number of “Fail” block groups exceeds the first predetermined value is the defective area. Therefore, since the block group set in which all the block groups have a high possibility of “Fail” can be determined as the defective area without performing the determination on the defective area for every block group, it is possible to reduce a time required for the rebuilding.

After the defect determination results of the block groups belonging to the process target block group set are set to “Fail” (B712), or in a case where the number of block groups of which the read-out defect determination results are “Fail” is equal to or less than the first predetermined value (No in B711), the CPU 10 updates the process target group set by setting the process target block group set as the block group set having the next smaller block group set number (B713).

Next, the CPU 10 determines whether all the block group sets are subjected to the defect determination (B714). In a case where it is determined that the defect determinations of all the block group sets are not performed (No in B714), the CPU 10 returns to B710 and reads the defect determination results of the block groups belonging to the process target block group set. On the other hand, in a case where it is determined that the defect determinations of all the block group sets are performed (Yes in B714), the CPU 10 enables the rebuild assist mode of performing the rebuild assist process in response to a read command or write command (hereinafter, referred to as a read/write command) received from the host 2 (B715). Then, the CPU 10 ends the process of determining the block group set as the defective area.

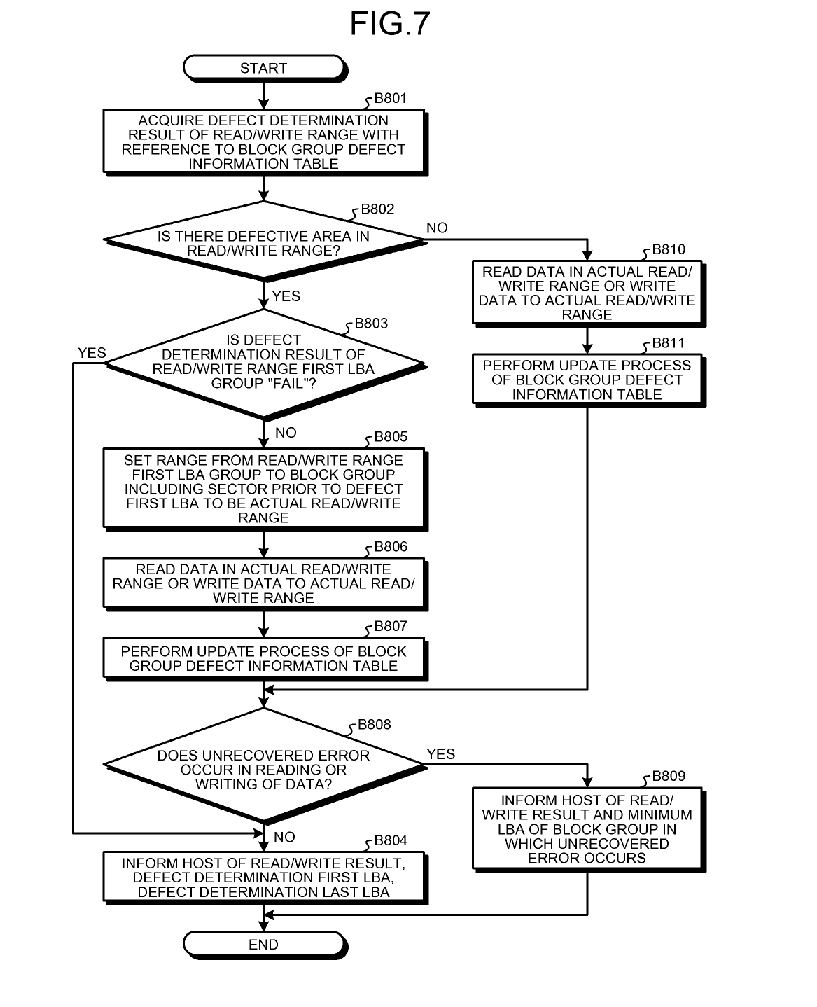

Next, the rebuild assist process by the magnetic disk device 1 according to the embodiment will be described using FIG. 7. FIG. 7 is a flowchart illustrating an example of a flow of a rebuild assist process by the magnetic disk device according to the first embodiment.

In a case where the rebuild assist process is performed in response to the read/write command received from the host 2 after the rebuild assist mode enabling process illustrated in FIG. 6, the CPU 10 acquires the defect determination results of the block groups included in a read/write range among the block groups of the disk 18 with reference to the block group defect information table 400 (B801).

Next, the CPU 10 determines whether there is a block group (the defective area) of which the defect determination result is “Fail” among the block groups included in the read/write range of the read/write command received from the host 2 (B802). In a case where it is determined that there is the defective area (Yes in B802), the CPU 10 determines whether the defect determination result of the block group (hereinafter, referred to as a read/write range first LBA group) included in a sector at a first LBA which is a minimum LBA is “Fail” among the block groups included in the read/write range with reference to the block group defect information table 400 (B803).

In a case where the defect determination result of the read/write range first LBA group is “Fail” (Yes in B803), the CPU 10 informs the host 2 of a defect determination first LBA and a defect determination last LBA (B804). The defect determination first LBA is a minimum LBA among the LBAs of the block groups which are included in the read/write range and have the defect determination result of “Fail”. The defect determination last LBA is a maximum LBA among the LBAs of the block groups which have the defect determination result of “Fail”.

On the other hand, in a case where the defect determination result of the read/write range first LBA group is not “Fail” (No in B803), the CPU 10 reads the defect first LBA which is the minimum LBA with reference to the block group defect information table 400 among the LBAs of the block groups which are included in the read/write range and have the defect determination result of “Fail”. Then, the CPU 10 sets a range from the read/write range first LBA group to the block group which includes a sector at the LBA next to the defect first LBA as a range on which the read or write process is actually performed in the read/write range of the read/write command received from the host 2 (an actual read/write range) (B805).

The CPU 10 performs reading or writing of data with respect to the actual read/write range (B806). After the reading and writing of data with respect to the actual read/write range, the CPU 10 performs the update process of the block group defect information table 400 illustrated in FIG. 3 (B807). Further, the CPU 10 determines whether an uncorrectable error (hereinafter, referred to as an unrecovered error) occurs in the reading or writing of data with respect to the actual read/write range (B808). In a case where the unrecovered error occurs (Yes in B808), the CPU 10 controls the host IF controller 14 to inform the host 2 of a read/write result which is a result of reading or writing data with respect to the actual read/write range and a minimum LBA among the block groups having the unrecovered error (B809).

In a case where the unrecovered error does not occur (No in B808), the CPU 10 informs the host 2 of the read/write result, the defect determination first LBA, and the defect determination last LBA through the host IF controller 14 (B804).

Further, in a case where it is determined that there is no defective area in the block groups included in the read/write range of the read/write command received from the host 2 (No in B802), the CPU 10 performs the reading or writing of data with respect to the read/write range of the read/write command received from the host 2 without any change (B810). Then, the CPU 10 performs the update process of the block group defect information table 400 illustrated in FIG. 3 (B811).

Further, the CPU 10 determines whether the unrecovered error occurs in the reading or writing of data with respect to the actual read/write range (B808). In a case where the unrecovered error occurs (Yes in B808), the CPU 10 controls the host IF controller 14 to inform the host 2 of the read/write result and a minimum LBA of the block group having the unrecovered error (B809).

On the other hand, in a case where the unrecovered error does not occur (No in B808), the CPU 10 controls the host IF controller 14 to inform the host 2 of the read/write result (B804).

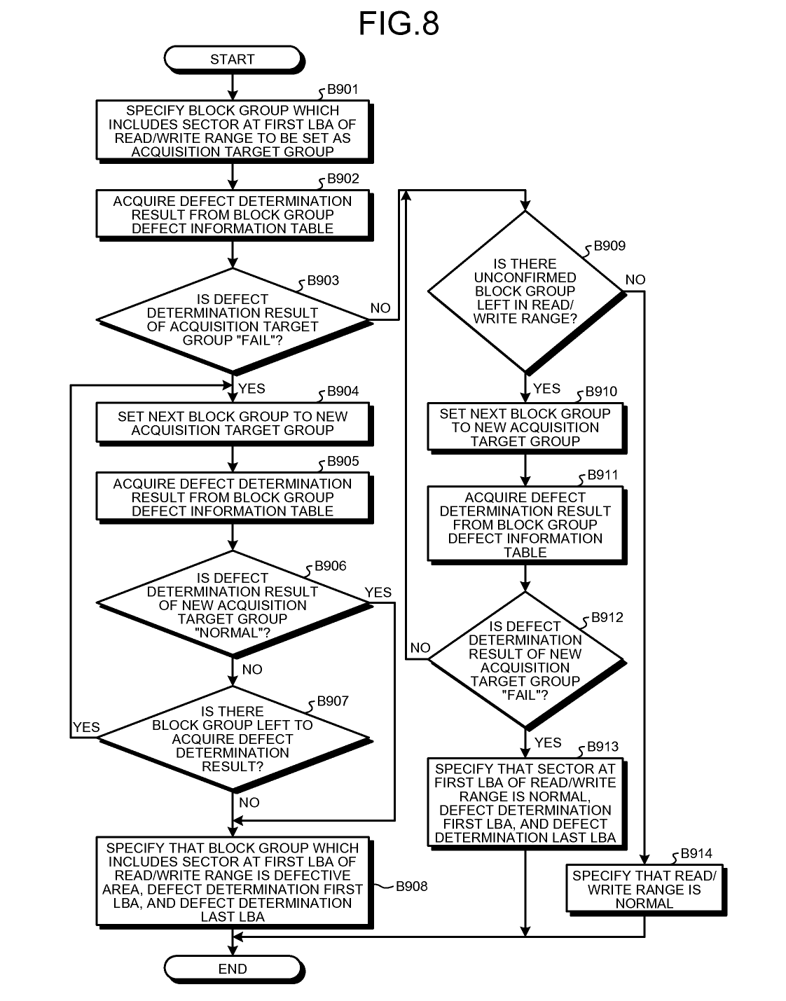

Next, a process of acquiring the defect determination result of the block group included in the read/write range (B801 in FIG. 7) will be described in detail using FIG. 8. FIG. 8 is a flowchart illustrating an example of a flow of an acquisition process of a defect determination result by the magnetic disk device according to the first embodiment.

The CPU 10 first specifies a block group which includes a sector at the first LBA of the read/write range, and sets the specified block group as an acquisition target group from which the defect determination result is acquired (B901). Further, the CPU 10 acquires the defect determination result of the acquisition target group from the block group defect information table 400 (B902).

Next, the CPU 10 determines whether the defect determination result of the acquisition target group is “Fail” (B903). In a case where the defect determination result of the acquisition target group is “Fail” (Yes in B903), the CPU 10 sets the block group (the next block group) including a sector at the next smaller LBA of the acquisition target group as a new acquisition target group (B904). Then, the CPU 10 acquires the defect determination result of the new acquisition target group from the block group defect information table 400 (B905).

The CPU 10 determines whether the defect determination result of the new acquisition target group is “Normal” (B906). In a case where the defect determination result of the new acquisition target group is “Fail” (No in B906), the CPU 10 determines whether there is a block group left to acquire the defect determination result (B907). In a case where there is a block group left to acquire the defect determination result (Yes in B907), the CPU 10 returns to B904 and sets a new acquisition target group again.

In a case where there is no block group left to acquire the defect determination result among the block groups included in the read/write range (No in B907), the CPU 10 specifies that the block group which includes a sector at the first LBA of the read/write range is the defective area, the defect determination first LBA, and the defect determination last LBA (B908). Herein, the defect determination first LBA is the first LBA of the read/write range. Further, the defect determination last LBA is the maximum LBA of the block group which comes to be last in the acquisition target groups. Then, the process is ended.

On the other hand, in a case where the defect determination result of the new acquisition target group is “Normal” (Yes in B906), the CPU 10 informs the host 2 of that the block group which includes a sector at the first LBA of the read/write range is the defective area, the defect determination first LBA, and the defect determination last LBA (B908). Herein, the defect determination first LBA and the defect determination last LBA are as described above.

Further, in a case where the defect determination result of the acquisition target group (the block group including the sector at the first LBA) is “Normal” (No in B903), the CPU 10 determines whether there is a block group (an unconfirmed block group) left to acquire the defect determination result among the block groups included in the read/write range (B909). In a case where there is no unconfirmed block group left (No in B909), the CPU 10 specifies that the read/write range is normal (B914). Then, the process is ended.

On the other hand, in a case where there is an unconfirmed block group left (Yes in B909), the CPU 10 sets the block group (the next block group) including a sector at the next smaller LBA of the acquisition target group as a new acquisition target group (B910). Further, the CPU 10 acquires the defect determination result of the new acquisition target group from the block group defect information table 400 (B911). Then, the CPU 10 determines whether the defect determination result of the new acquisition target group is “Fail” (B912). In a case where the defect determination result of the new acquisition target group is “Normal” (No in B912), the CPU 10 returns to B909 and determines whether there is an unconfirmed block group left.

In a case where the defect determination result of the block group which is a newly acquired target is “Fail” (Yes in B912), the CPU 10 specifies that the block group which includes a sector at the first LBA of the read/write range is normal, and the defect determination first LBA (B913). Herein, the defect determination first LBA is a minimum LBA of the block group which finally becomes an acquisition target group. Further, the CPU 10 performs the same processes as those of B904 to B908 based on the specified defect determination first LBA, and specifies a last LBA in the defect range (B913).

According to the first embodiment, a block group has been determined as the defective area when a delay time of each block group obtained based on information relating to the access history with respect to the block group exceeds the predetermined allowable delay time. As a result, it is possible to reduce a risk such as a case where the defective area is not correctly predicted or a case where the defective area is excessively predicted. Therefore, it is possible to obtain an effect that a time required for the rebuilding is reduced.

In the first embodiment, the CPU 10 determines that the block group of which the delay time of the block group exceeds the predetermined allowable delay time is the defective area, but the invention is not limited thereto. The CPU 10 may make a determination on each block group whether the block group is the defective area based on the information relating to the access history with respect to the block group. For example, the CPU 10 may determine that the block group having a retry execution rate exceeding a predetermined allowable retry execution rate is the defective area based on the information relating to the access history with respect to the block group. Herein, the predetermined allowable retry execution rate is an execution rate at which retrying is allowed to the block group. Further, the retry execution rate, for example, is obtained by subtracting the number of times of the retrying indicated by the retry information stored in the block group defect information table 400 from the number of blocks stored in the block group defect information table 400.

Further, in the embodiment, the description has been made about examples in which the update process of the block group defect information table illustrated in FIG. 6, the rebuild assist mode enabling process illustrated in FIG. 6, and the rebuild assist process illustrated in FIGS. 7 and 8 are performed by one CPU 10 included in the magnetic disk device 1, but the invention is not limited thereto. For example, the update process, the rebuild assist mode enabling process, and the rebuild assist process of the block group defect information table may be performed by the CPU including an external mechanism such as the host 2, or the CPU including an external mechanism such as the host 2 may perform a part of the update process, the rebuild assist mode enabling process, and the rebuild assist process.

### Second Embodiment

In the second embodiment, the block group set is classified into upper-level group sets (second storage area sets) which include a plurality of block group sets which are physically arranged in common with each other. Then, in the second embodiment, an upper-level group set in which the number of block group sets determined as the defective areas exceeds a second predetermined value is determined as the defective area. In the following description, the same descriptions as those in the first embodiment will not be repeated.

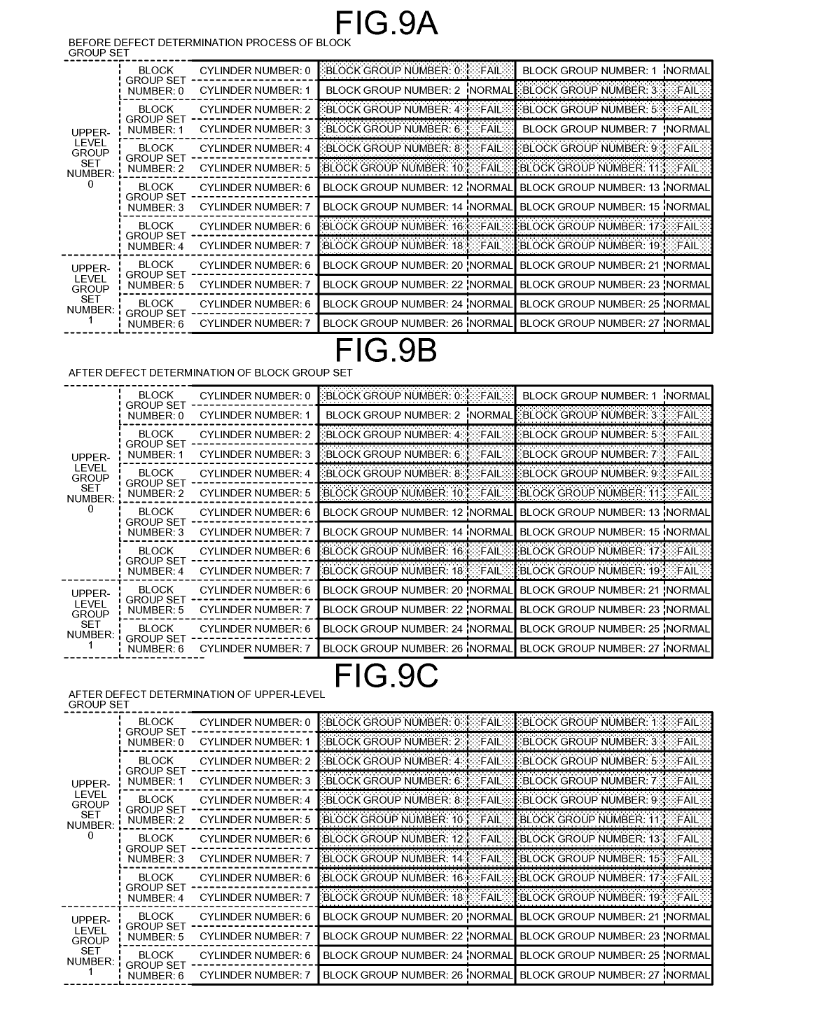

FIGS. 9A, 9B, and 9C are diagrams for describing an example of a process of determining that an upper-level group set is a defective area in a magnetic disk device according to a second embodiment. FIG. 9A is a diagram illustrating an example of the defect determination result of the block group before the defect determination process of the block group set. FIG. 9B is a diagram illustrating an example of the defect determination result of the block group after the defect determination process of the block group set. FIG. 9C is a diagram illustrating an example of the defect determination result of the upper-level group set after the defect determination process of the upper-level group set. In the embodiment, as illustrated in FIGS. 9A, 9B, and 9C, the CPU 10 assigns five block group sets to the upper-level group set according to a physical arrangement of the block group set. The upper-level group set (the upper-level group set number: 0) of the block group set numbers 0 to 4 and the upper-level group set (the upper-level group set number: 1) of the block group set numbers 5 to 9 (the block group set number: 7 and the subsequent numbers are not illustrated) are exemplified.

The CPU 10 determines the number of defective areas in the block group set of the block group set number 0 exceeds the first predetermined value (“2” in the embodiment) by the same method as that of the processes shown in B710 to B714 of FIG. 6. Then, the CPU 10 determines the block group set having the number of defective areas exceeding the first predetermined value as the defective area. Through the process (the defect determination process of the block group set), the CPU 10 determines all the block groups (the block groups of the block group numbers 4 to 7, 8 to 11, and 16 to 19) having the block group set (the block group set of the block group set numbers 1, 2, and 4) as the defective areas. The defect determination result of the block group set after the process is in the state illustrated in FIG. 9B. Among the block group set numbers 0 to 4 classified into the upper-level group set number 0, the number of block group sets (the block group sets having the block group set numbers 1, 2, and 4) determined as the defective area exceeds the second predetermined value (“2” in the embodiment). Herein, the second predetermined value is the number of block group sets of which the upper-level group sets are determined as the defective areas.

Therefore, as illustrated in FIGS. 9A, 9B, and 9C, the CPU 10 determines all the block groups (the block groups of the block group numbers 0 to 19) included in the block group set numbers 0 to 4 classified into the upper-level group set number 0 as the defective areas. Accordingly, the CPU 10 sets the upper-level group set number 0 as the defective area.

According to the second embodiment, the upper-level group set of which the block group set determined as the defective area exceeds the second predetermined value is determined as the defective area. As a result, it is possible to determine the upper-level group set of which the block group sets all have a possibility to be the defective area as the defective area. Therefore, it is possible to obtain an effect that a time required for the rebuilding is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information-processing device comprising:
a storage medium; and
a controller configured to acquire a delay time in access to storage area included in the storage medium for every storage area with reference to a time at which an access is performed without preforming retrying on the storage area based on first information relating to an access history with respect to the storage area, and to determine the storage area of which the delay time exceeds a predetermined allowable delay time as a defective area.

2. The information-processing device of claim 1, wherein
the controller further detects an abnormality of the storage medium for every physical element of the storage medium, and determines the storage area corresponding to the physical element having the detected abnormality as the defective area.

3. The information-processing device of claim 1, wherein
the storage medium is divided into a first storage area set having the plurality of storage areas according to classification condition based on a physical element of the storage medium, and
the controller determines the first storage area set of which the number of storage areas determined as the defective areas exceeds a first predetermined value as the defective area.

4. The information-processing device of claim 3, wherein
the storage medium is divided into second storage area sets which includes the plurality of first storage area sets which share common physical layout, and
the controller determines the second storage area set of which the number of first storage area sets determined as the defective areas exceeds a second predetermined value as the defective area.

5. The information-processing device of claim 1, wherein
the first information comprises the number of times of retrying performed on the storage area.

6. The information-processing device of claim 1, wherein
the first information comprises the number of alternation areas based on an alternation process which is performed in access to the storage area.

7. The information-processing device of claim 1, wherein
the controller further determines the storage area of which a retry execution rate based on the first information exceeds a predetermined execution rate as the defective area.

8. An information-processing method in an information-processing device comprising a storage medium, the method comprising:
acquiring a delay time in access to storage area included in the storage medium for every storage area with reference to a time at which an access is performed without performing retrying on the storage area based on first information relating to an access history with respect to the storage area, and
determining the storage area of which the delay time exceeds a predetermined allowable delay time as a defective area.

9. The information-processing method of claim 8, wherein
detecting an abnormality of the storage medium for every physical element of the storage medium, and
determining the storage area corresponding to the physical element having the detected abnormality as the defective area.

10. The information-processing method of claim 8, wherein
the storage medium is divided into a first storage area set having the plurality of storage areas according to classification condition based on a physical element of the storage medium, and
determining the first storage area set of which the number of storage areas determined as the defective areas exceeds a first predetermined value as the defective area.

11. The information-processing method of claim 10, wherein
the storage medium is divided into second storage area sets which includes the plurality of first storage area sets which share common physical layout, and
determining the second storage area set of which the number of first storage area sets determined as the defective areas exceeds a second predetermined value as the defective area.

12. The information-processing method of claim 8, wherein
the first information comprises the number of times of retrying performed on the storage area.

13. The information-processing method of claim 8, wherein
the first information comprises the number of alternation areas based on an alternation process which is performed in access to the storage area.

14. The information-processing method of claim 8, wherein
determining the storage area of which a retry execution rate based on the first information exceeds a predetermined execution rate as the defective area.
